(19) United States
(12) Patent Application Publication
(10) Pub. No.: US 2007/0213905 A1
(43) Pub. Date: Sep. 13, 2007

(54) Driver assistance system having a safety function

(75) Inventors: Kilian Funk, Muenchen (DE); Matthias Kopf, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: BMW Motoren Werke Aktiengesellschaft, Muenchen (DE)

(21) Appl. No.: 11/797,890

(22) Filed: May 8, 2007

Related U.S. Application Data
(63) Continuation of application No. PCT/EP05/11245, filed on Oct. 19, 2005.

(30) Foreign Application Priority Data
Nov. 11, 2004 (DE) 10 2004 054 472.7

(51) Int. Cl. B62D 6/00

(52) U.S. Cl. 701/45; 701/41

(57) ABSTRACT

A driver assistance system for motor vehicles having two operating modes is described. In each operating mode different partial functions of the driver assistance system are activated. The driver assistance system also has a control element for activating an operating mode of the driver assistance system, so that an operating mode activated by the control element is activated for the duration of the operation of the control element.

### CROSS REFERENCE TO RELATED APPLICATIONS

This application is a continuation of PCT International Application No. PCT/EP2005/011245, filed Oct. 19, 2005, which claims priority under 35 U.S.C. § 119 to German Patent Application No. 10 2004 054 472.7 filed Nov. 11, 2004, the entire disclosures of which are herein expressly incorporated by reference.

### BACKGROUND AND SUMMARY OF THE INVENTION

The invention relates to a driver assistance system for motor vehicles having two operating modes, in each mode different partial functions of the driver assistance system being activated.

A number of driver assistance systems currently exist which have the purpose of aiding the driver's tasks. A typical example of a driver assistance system is an ACC system (Adaptive Cruise Control). In the case of such a driver assistance system, the velocity of the vehicle is automatically controlled to a desired velocity definable by the driver. Furthermore, such a driver assistance system includes range sensors through which vehicles driving ahead can be determined, or the distance from vehicles driving ahead can be determined. If the distance from the vehicle driving ahead threatens to be too narrow, the velocity of the vehicle is reduced such that a safe distance to the vehicle driving ahead is maintained. In general, an ACC system is activated by a switch or a lever. For the deactivation, either the switch or the lever has to be operated again, or the vehicle brake has to be applied.

Furthermore, driver assistance systems are known which warn the driver in a critical traffic situation or automatically brake the vehicle in the event of a possible collision with an object or even initiate a self-sufficient emergency braking.

A typical driver assistance system is known from German Patent Document DE 102 18 698 A1. Here, the individual partial functions of the driver assistance system can be individually activated or deactivated by a control element by a repeated pressing or rotating of the control element. In this case, it is a disadvantage that, particularly in critical traffic situations such as during a lane change or a passing maneuver in which the driver depends on certain functions of the driver assistance system, the driver's attention is diverted from the traffic situation by the repeated rotating or pressing of the control element in order to reach the desired operating mode.

The present invention provides an improved driver assistance system by which, mainly in critical traffic situations, the driver's attention is not diverted by the activating or deactivating of certain partial functions of the driver assistance system.

According to an exemplary embodiment of the invention, the driver assistance system includes at least one control element for activating a safety operating mode of the system for the duration of operation of the control element. Advantageous further developments are described further in the following.

The exemplary driver assistance system for motor vehicles according to the invention, includes at least two operating modes, so that in each operating mode different partial functions of the driver assistance system are activated, and includes at least one control element for activating at least one operating mode of the driver assistance system. In the system, the operating mode activated by the control element is active for the duration of the operation of the control element.

The driver assistance system according to an embodiment of the invention offers the advantage that, as a result of the fast and simple manner of activating a specific operating mode, which is advantageously designed for critical traffic situations, the driver's attention is not unnecessarily diverted from the traffic situation. The control element can advantageously be a key mounted on the steering wheel. When operating the key, the driver can therefore leave both hands on the steering wheel and concentrate on the traffic action. The control element may be a separate element, specifically for activating the operative mode active as a result of a continuous operation, for example a safety operating mode, or it may be a control element through which the conventional operating mode of the driver assistance system as well as the safety mode can be activated.

Advantageously, exclusively the operating mode activated by the exemplary control element is activated for the duration of the operation of the control element. As a result, those operating modes which were previously switched active are deactivated for the duration of the operation of the control element. As soon as the driver releases the control element again, these operating modes of the driver assistance system will be activated again.

The driver assistance system according to the embodiment advantageously includes a warning function and/or an intervention function, and the operating mode activated for the duration of the operation is further developed such that, for the duration of the operation of the control element, the warning function and/or the intervention function is activated with a longer prewarning time and/or at an earlier intervention point in time.

If the driver assistance system includes, for example, a safety system where the traffic driving ahead is monitored by suitable sensors and, when a critical traffic situation is detected the driver is warned, the operating mode active during the continuous operation of the control element may be further developed such that the safety system is reparametrized in comparison to the normal operation of the safety system, so that the driver's attention is drawn earlier to a critical traffic situation.

The exemplary driver assistance system may advantageously include at least one range control function, and the operating mode activated for the duration of the operation may be further developed such that only the range control function is activated for the duration of the operation of the control element.

A driver assistance system having a range control function may, for example, be an ACC system, which has a speed adjusting function and a range control function. The operating mode active during the continuous operation is designed such that only the range control function but not the speed adjusting function is active. The velocity of the vehicle continues to be defined by the position of the accelerator pedal.

If the range control function includes a warning function, the latter may advantageously emit an acoustic, visual or haptic signal when there is a falling below a defined distance from the vehicle driving ahead. The haptic signal may, for example, be a vibrating of at least a portion of the steering wheel. If the vehicle is equipped with an active accelerator pedal, a counterforce may also be generated onto the accelerator pedal when there is a falling below the distance.

However, if the range control function includes a range adjusting function, the latter adjusts the vehicle to a predefined distance with respect to the vehicle driving ahead.

In this operating mode, the predefined distance should not be adjusted by the driver. Rather, this distance advantageously corresponds to the distance of the vehicle from the vehicle driving ahead which exists at the point in time of the activation of the safety mode. Thus, the driver's attention is not unnecessarily diverted when he activates this operating mode.

Advantageously, in this safety operating mode of the driver assistance system, which is active only during a continuing operation of the control element, there can be no falling below the automatically adjusted distance by an intervention of the driver, for example, by operating the accelerator pedal. It is therefore ensured that a collision is avoided even if the driver accidentally should further depress the accelerator pedal in a tense situation.

Advantageously, the operating mode activated for the duration of the operation of the control element can also be further developed such that another driver assistance system is activated for the duration of the operation of the control element.

If the driver assistance system is a system which, during a continuous operation of the control element, activates a range control function, a supporting system for staying within a lane and/or a warning system against leaving a lane may additionally be active, for example, for the duration of the operation.

### BRIEF DESCRIPTION OF THE DRAWINGS

Other objects, advantages and novel features of the present invention will become apparent from the following detailed description of the invention when considered in conjunction with the accompanying drawings.

In the following, the invention will be explained in detail with reference to the following drawings.

FIG. 1 is a diagram of a simplified construction of a driver assistance system according to an embodiment of the invention; and

FIG. 2 is a diagram of a simplified automatic condition chart for an operating mode of an ACC system active during a continuous operation, according to an embodiment of the invention.

### DETAILED DESCRIPTION OF THE DRAWINGS

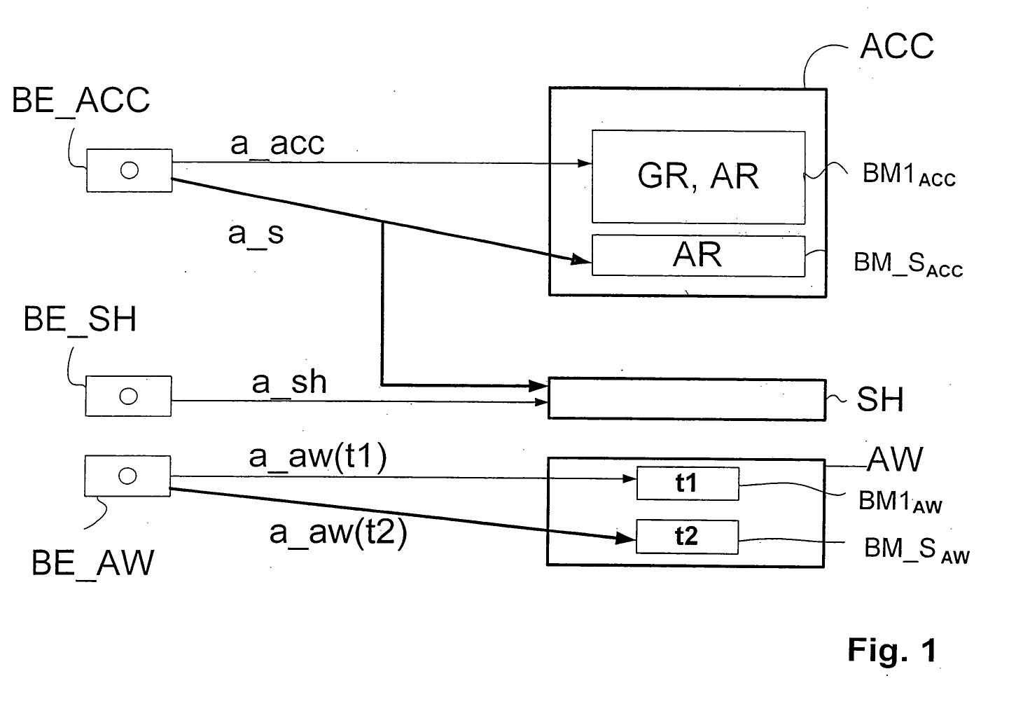

FIG. 1 illustrates three exemplary driver assistance systems ACC, SH and AW which are activated during the operation of the respective control element BE_ACC, BE_SH and BE_AW in an operating mode. The driver assistance system ACC is a so-called ACC driver assistance system which, in the normal operation, carries out an adjusting of the speed GR in connection with an adjusting of the range AR. The driver assistance system SH is a known lane tracking driver assistance system. The driver assistance system AW is a collision warning driver assistance system.

According to this embodiment, the ACC driver assistance system ACC can be operated in the two operating modes BM1_{ACC} and BM_S_{ACC}. In the operating mode BM1_{ACC}, the partial speed adjusting GR and range adjusting AR functions are activated, in which case, in the safety operating mode BM_S_{ACC}, only the partial range adjusting AR function is activated. The ACC driver assistance system is connected with the control element BE_ACC, during whose single operation, a signal a_acc is sent to the ACC driver assistance system ACC for activating the operating mode BM1.

Instead of a single operation of the control element BE_ACC for reaching the conventional operating mode BM1_{ACC} of the ACC driver assistance system, as a result of the continuous operation of the control element BE_ACC by the signal a_s, the safety operating mode BM_S_{ACC} of the ACC driver assistance system can be activated. Simultaneously, as a result of the continuous operation of the control element BE_ACC, the lane tracking driver assistance system SH is also activated in order to additionally support the driver.

The exemplary collision warning driver assistance system AW can be operated in both operating modes BM1_{AW} and BM_S_{AW}. Both operating modes can be activated by the same control element BE_AW. However, in another exemplary embodiment, it is also possible to activate the two operating modes BM1_{AW} and BM_S_{AW} by different control elements. In the case of a single operation of the pertaining control element BE_AW, the signal a_aw(t1) activates the operating mode BM1_{AW}. This conventional operating mode BM1_{AW} is further developed such that, in the case of a critical situation with a prewarning time t1, an acoustic, visual or haptic signal is emitted to the driver.

Instead of a single operation of the control element BE_AW for activating the operating mode BM1_{AW} of the collision warning driver assistance system AW, during a continuous operation of the control element BE_AW, using the signal a_aw(t2), the safety operating mode BM_S_{AW} of the collision warning driver assistance system AW is activated. This safety operating mode BM_S_{AW} is further developed such that the prewarning time, during which a signal is emitted to the driver because of a critical traffic situation, is increased, whereby the collision warning driver assistance system AW reacts earlier to critical traffic situations.

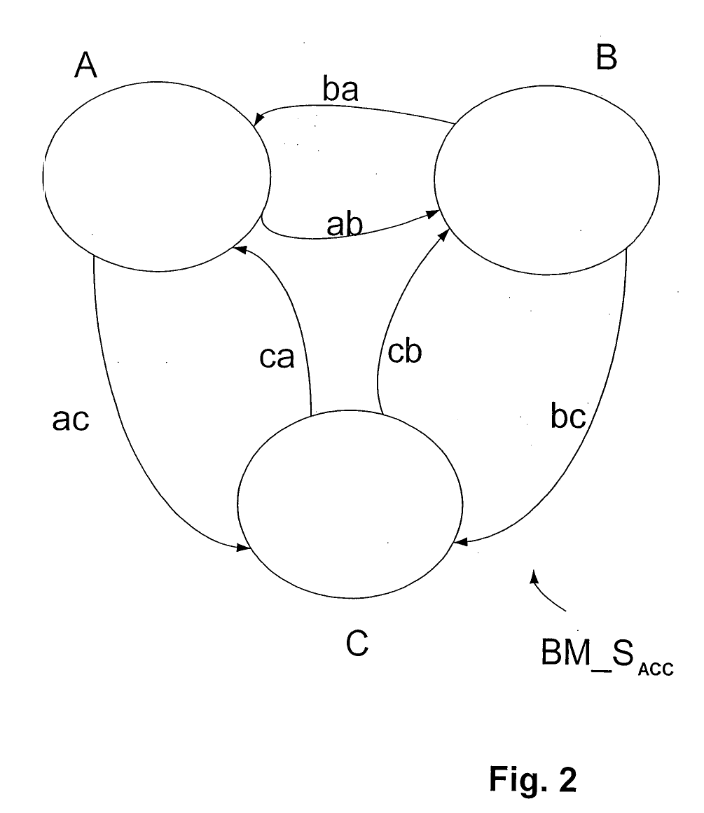

FIG. 2 illustrates a simplified automatic condition chart for the exemplary ACC driver assistance system ACC in the safety operating mode. In the switched-off condition C, no intervention of the ACC driver assistance system takes place. For the duration of the operation of the control element during an “open travel”, when no vehicle driving ahead is detected, a transition takes place to condition A by way of path ca. In this condition A, the desired speed is further implicitly predefined by the driver using the accelerator pedal position. However, when, for the duration of the operation of the control element, a “following travel” is detected, if the safety operating mode is just being activated, condition B is reached by way of path cb, or, in the case of an already activated safety mode and a previously detected “open travel”, condition B is reached by way of path ab. In this condition B, either the safety distance of the vehicle from the vehicle driving ahead is maintained when the safety mode is activated, or a safety distance to the vehicle driving ahead is maintained which is fixedly adjusted in the safety operating mode. In the case of this safety operating mode, it is significant that in condition B it is not permitted for the actual distance to the vehicle ahead to fall below the safety distance, even during an intentional operation of the accelerator pedal by the driver. When, in condition B, for example, as a result of a passing maneuver or a turn-off operation, it is detected that there is no longer a vehicle driving ahead, a transition takes place from condition B by way of path ba to condition A.

When the safety operating mode is deactivated, for example by releasing the control element, in the case of a previously detected “open travel”, a transition takes place from condition A by way of path ac to condition C. In the case of a previously detected vehicle driving ahead, a transition takes place from condition B by way of path bc to condition C.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A driver assistance system for motor vehicles having first and second operating modes, different first and second partial functions of the driver assistance system being activated in corresponding ones of the operating modes, comprising at least one control element for activating operating modes of the driver assistance system, wherein a safety operating mode activated by the control element is activated for a duration of operation of the control element.

2. Driver assistance system according to claim 1,
wherein the control element comprises a key mounted on a steering wheel.

3. Driver assistance system according to Claim l, wherein the operating mode activated by the control element is an exclusive mode activated for the duration of operation of the control element.

4. Driver assistance system according to claim 1, further comprising one of a warning function and an intervention function, wherein the safety operating mode activated for the duration of operation of the control element further comprises activating the one of the warning function and the intervention function for the duration of operation of the control element.

5. Driver assistance system according to claim 1, further comprising at least one range control function, wherein the safety operating mode activated for the duration of operation of the control element only activates the at least one range control function for the duration of operation of the control element.

6. Driver assistance system according to claim 5,
wherein the range control function comprises a warning function emitting one of an acoustic, visual and haptic signal in response to a falling below a predefined distance from a vehicle driving ahead.

7. Driver assistance system according to claim 5,
wherein the range control function comprises a range adjusting function to maintain a predefined distance from the vehicle driving ahead.

8. Driver assistance system according to claim 7, wherein the range adjusting function prevents falling below the predefined distance.

9. Driver assistance system according to claim 7, wherein the predefined distance corresponds to a distance from the vehicle driving ahead existing at a point in time of activation of the safety operating mode.

10. Driver assistance system according to claim 1, wherein the operating mode activated for the duration of operation further comprises an additional driver assistance system activated for the duration of operation of the control element.

11. Driver assistance system according to claim 1, further comprising one of a warning function and an intervention function, wherein the safety operating mode activated for the duration of operation of the control element further comprises activating the one of the warning function and the intervention with one of a longer pre-warning time and an earlier intervention point in time.

12. A driver assistance system for vehicles, comprising:
a control element operable by the driver to select active operating modes having different partial functions; and
a safety operating mode selectable with the control element, the safety operating mode being activated during a duration of operation of the control element.

13. The system as claimed in claim 12, wherein the safety operating mode is deactivated at an end of operation of the control element.

14. The system as claimed in claim 12, wherein the safety operating mode exclusively is activated during a duration of operation of the control element.

15. The system as claimed in claim 12, wherein the safety operating mode comprises a range control function having one of a distance to a vehicle ahead warning function and a vehicle ahead distance maintaining function.

16. The system as claimed in claim 12, wherein the safety operating mode comprises a lane tracking driver assistance system.

17. The system as claimed in claim 15, wherein the vehicle ahead distance maintaining function comprises elements for adjusting a vehicle speed to maintain a desired range.

18. An adaptive cruise control system, comprising:
control elements providing selectable active operating modes having different partial functions; and
a control element for selecting and activating the active operating modes of the control elements, and a safety operating mode,
wherein the safety operating mode is activated for a duration of operation of the control elements.

19. The adaptive cruise control system as claimed in claim 18, wherein the selectable active operating modes comprise at least one of a speed adjustment mode, a lane tracking mode and a collision warning mode.

20. The adaptive cruise control system as claimed in claim 18, further comprising a range maintaining mode adjusting a speed to maintain a distance to a vehicle driving ahead.
